(19) United States
(12) Patent Application Publication
(10) Pub. No.: US 2001/0039517 A1
(43) Pub. Date: Nov. 8, 2001

(54) Method for selling product and product sales system

(76) Inventor: Toshiro Kawakatsu, Osaka (JP)

Correspondence Address: PRICE, GESS & UBELL, 2100 S.E. Main Street, Suite 250, Irvine, CA, 92714, US

(21) Appl. No.: 09/816,060

(22) Filed: Mar. 23, 2001

(30) Foreign Application Priority Data
Apr. 11, 2000 (JP) 2000-109752

(51) Int. Cl. G06F 17/60

(52) U.S. Cl. 705/26

(57) ABSTRACT

The present invention provides a method for selling a product and a product sales system which enable an effective use of both shops on the internet and real shops in order to enable consumers to utilize each shops as an actual place where consumers can inspect products by actually seeing them in the commercial trade on the internet as well and to enable the shops to expand their sales opportunity.

In the present invention, product item number information which specifying each item of products and includes shop information specifying shops which sell the product is added to each item of products so that the shops sell the product while disclosing the product item number information, and an administrator which affiliated with each shop operates a purchase support site which has at least a homepage for each consumer, a product information page for displaying information on each item of products corresponding to each product item number information input by the consumer on this homepage, and a product purchase page which enables consumers to purchase a product disclosed on this product information page thereby the administrator notifies the purchased product to the respective shop through the product purchase page.

### BACKGROUND OF THE INVENTION

1. Field of the Invention

The present invention relates to a method for selling a product and a product sales system.

2. Description of the Prior Art

In recent years, along with the prevalence of information processing apparatus such as a personal computer or the like, a mobile telephone and a portable information terminal, information is frequently exchanged using an electric telecommunication circuit and is utilized in the commercial world. In particular, along with the development of the internet, consumers of any product can compare and review products before purchasing the products by making use of the internet. Still more, it has become possible for consumers to place an order of product through the internet.

Furthermore, manufacturers of each product utilizes the internet for the advertisement and sales promotion of their own products and operates their own web sites. However, not a few consumers feel reluctant to conduct any commercial trade on the basis of the information made public only on the internet in consideration of the current situation in which frauds and crimes using the internet are rapidly increasing.

Furthermore, not a few people enjoy window-shopping rather than internet shopping in which the consumers view products on computer monitors because they can directly see the products which are displayed in an attractive manner by walking around downtown and actually visiting shops. In the case of products deeply dependent on individual differences or the like, such as product preferences of consumers, in particular when the products are clothing, not a few consumers have felt reluctant to purchase such products without seeing the actual products.

Furthermore, consumers enjoy finding better products while visiting several shops even for similar kinds of products. Then, in the case of products whose standard retail prices are not strictly observed, consumers recognize that the sales prices are different from one shop to another, and they tend to feel pleasure in finding products which can be purchased at cheaper prices.

However, consumers have happened to forget the location of the shop where they found a product that has caught their attention when they visit many shops for shopping. Then, even when they determine to purchase the product later, they have to go to the trouble of going back their way for finding the shop, which resulted in wasting their time and physical power. Furthermore, even when they go back to the shop, it sometimes happen that the product has been already sold out with the result that they needed to abandon the purchase of the product with disappointed feeling, or they needed to request the shop to get the product from the manufacturer and to visit the shop again at a later time, or request the shop to deliver the product later.

Otherwise, when their willingness to purchase the product is weak, they do not feel like going back to the shop. Furthermore, when they do not remember the shop clearly, they most likely to give up purchasing the product from the very beginning. Still furthermore, there sometimes arises a situation in which the consumers cannot remember detailed information on the product such as the price and the material thereof. Thus, it has sometimes become difficult for them to consider purchasing the product later.

Besides, in the case where the price of the product is expensive, consumers sometimes desire to consult with a third person. However, since an oral explanation of a product is limited, it is desirable that they go to the shop together. However, it has been troublesome to visit the shop with the third person at a later time. Still, even in the case where they visit the shop to inspect the product again, it sometimes happens that they have to give up inspecting the product because the product is out of stock, and they have to abandon purchasing the product, which leads to loss of sales opportunity from the perspective of the shop. In such a case, it was extremely difficult to find out the same product in other shops.

That is, in the case where the consumers retrieve shops and manufacturers which sell the desired product by using the internet, it is extremely difficult to accurately retrieve the information related to the sales of the desired product among the vast information published on the internet, so that a lot of time is wasted in some cases. Furthermore, it sometimes happens that each shop does not publish the information on the product on the internet, so that the retrieval of the product using the internet used to produce no result.

On the other hand, shops which sell each product worry that their profit would be lowered because of the prevalence of direct sales using the internet with the result that they feel some risk in the increase of the internet shopping and back away from the internet shopping. As a consequence, each shop has been reluctant to use the internet for the expansion of the sales opportunity.

### SUMMARY OF THE INVENTION

The present invention has been made in view of such actual situation, and an object of the invention is to provide a method for selling a product and a product sales system which enable an effective use of both shops on the internet and real shops in order to enable consumers to utilize each shops as an actual place where consumers can inspect products by actually seeing them in the commercial trade on the internet as well and to enable the shops to expand their sales opportunity.

According to the present invention, means for attaining the object is constituted as the following manner.

That is, a product sales method for selling products according to a first aspect of the present invention is characterized by comprising:

adding product item number information which specifies each item of products and includes shop information specifying shops which sell the product to each item of products so that the shops sell the product while disclosing the product item number information; and

allowing an administrator to operate a purchase support site which has at least a homepage for each consumer, a product information page for displaying information on each item of products corresponding to each product item number information input by the consumer on this homepage, and a product purchase page which enables consumers to purchase a product disclosed on this product information page and which affiliates with each shop thereby allowing the administrator to notify the purchased product to the respective shop through the product purchase page.

Consequently, the consumer can obtain accurate information on the product by inputting product item number information they have found by visiting shops on the homepage for consumers which is included in the purchase support site by using a mobile terminal (a mobile telephone corresponding to the network and PDA (Personal Digital Assistants)) or an installation type information processing apparatus. The administrator can supply detailed information on the product consumers seek by referring to product information database already built up, which results in enabliry to reduct only into the necessary information, through utilizing product information page of the purchase support site.

Furthermore, the consumer can also purchase a product disclosed on the product information page from the product purchase page so that they can purchase the product later without going back to the shop again only by transmitting the product item number information on the product which caught his/her attention during window-shopping at each shop to the server which operates the purchase support site via the homepage. At this time, since the purchase support site selects only information on the product with the product item number information input by the consumer, the consumer is not overwhelmed by a huge amount of information and can instantly find only the product they are interested so that they can purchase the product.

Furthermore, at the purchase support site, the shop can gain the profit obtained through the sales opportunity as its own profit by allowing the standard sales price of the product (or the product sales price at the shop where the consumer visited) to be displayed on the site. That is, the purchase support site of the present invention is formed with affiliation with each shop so that the shops can effectively participate in the opening of the internet shopping by the purchase support site.

On the other hand, there is provided an advantage in that the consumer can select and purchase the product they require more among the similar products by selecting several items of products which attracted the attention of the consumer at one time window shopping. In particular, since the consumer actually visits each shop, actually sees the product and confirms the quality thereof so that the consumer does not have to feel any reluctance to purchase the product through the internet.

Since the product purchased by the consumer is notified to the shop, product is supplied to the consumers from the shop and the shop can gain the profit from such sales. Besides, even in the case where the product is supplied to the consumer from the side of the administrator, the purchase of the product is notified to the shop so that shop can get the profit from the administrator. In such a case, the shop is not required to stock a large quantity of products. That is, since the shop can yield the profit with ease even in the sales of the product through the internet, the shops can actively participate in the internet shopping.

When each shop is located in a restricted place such as a department store and a large scale store, it becomes possible that the department store and the large scale store can serve as an administrator so that the stores can deliver the product to the consumer at one time and the customer can settle the account of the product at one time when getting out of the department store and large scale stores. That is, the customer is not required to carry the products at all times and the customer is not required to settle the account for each item of products. Incidentally, as a network to be used at this time, a connection of each terminal using the LAN and the intranet can be used.

Incidentally, as to the terminal with which the consumers input product item number information on each of the products, mobile terminals such as the mobile telephones and PDA's are useful because the consumer can input the product item number information on a way to the shop and at the front of the shop by using these terminals which they carry at all times. However, it is possible to input this product item number information by using the information processing device installed in each shop. In such a case, it is not required for the consumer to carry any special terminal.

In the case where the product item number information includes manufacturer information for specifying the manufacturer of the product, each manufacturer notifies a serial number for each of the manufacturers to each shop and the administrator in accordance with sales a new product, and the administrator prepares the product item number information by using the manufacturer information for specifying the manufacturer and the serial number, the product can be supplied by attaching the product item number information to the most recent product so that the shop and the administrator can swiftly deal with the sales of new products. Furthermore, it is not required for manufacturers to talk on the allocation of the serial numbers.

In the case where the product item number information includes clerk information for specifying the clerk on the side of the shop, the clerk directly associated with the sales of products can be specified, and an attempt can be made to produce the sales result of the clerk. Consequently, each clerk can actively notify the product item number information to the customer.

In the case where the shop notifies the number of stock of each product and the administrator notifies at least the presence of the stock of each product via the purchase support site to the consumer, the consumer can purchase the product just on time while confirming the stock state of each product.

In the case where the administrator monitors the decrease state of the number of the stock of each product and requests the additional production of the product which is insufficient in the stock, the manufacturer can swiftly learn the product which sells well and can appropriately conduct the additional production of the product, so that the manufacturer can carry out production of the product without waste. Furthermore, it is possible for the consumer to minimize the situation in which the product is out of stock.

In the case where the administrator monitors the decrease state of the number of the stock of each product, and the administrator takes a procedure for enabling the product sold at a shop where the stock of the product is insufficient to be delivered to the consumers from a different shop where the stock of the same product is superfluous, the product is supplied in such a manner that no surplus of the product nor the lack of the product is generated as a whole even with respect to the product whose supply differs from one area to another, so that a smooth distribution of the product can be promoted. Furthermore, it becomes possible to confirm the sale state of the product at each shop with the result that each shop can improve the sales of the product by accurately changing the display method of the product.

In the case where the administrator prepares the product reservation page which enables the consumer to make a purchase reservation of the product which is introduced on the product information page, and a down payment of the reserved product is made, the consumers can make a down payment on the product by using the product reservation page when the consumers are at a loss whether or not they purchase the product with the result that the consumers can purchase the product after good consideration on the purchase thereof.

Furthermore, the administrator can promote more smooth distribution of the product by allowing the number of purchase reservation to be reflected on the stock control of the product at each shop through affiliation of the purchase reservation from the consumer with the monitor on the number of the stock of the product described above. That is, such sales promotion can be linked to the expansion of the sales opportunity of the product.

In the case where the administrator transmits the product item number information of the product input by the consumer by using the purchase support site to a different consumer home page specified by the consumers, the consumer who is at a loss as to whether the consumer should purchase a product and consult the content of the product with the third person can request the third person to confirm the content which cannot be orally explained by transmitting the product item number information to the home page of the third person, and the consumer can take the third person's advice about purchasing a product. Furthermore, this enables the consumer to introduce a product with which the customer is satisfied to his or her fellows and enables him or her to get information on the product when the consumer visits the shop and finds a product he or she often hears that his or her fellows want.

A product sales system according to a second aspect of the invention is characterized by comprising:

product item number information which specifies each item of product and which is attached with shop information specifying a shop which sells the product;

a shop which sells the product while disclosing the product item number information;

a purchase support site having a home page for each of the consumers, a product information page for displaying information on each product corresponding to the product item number information input by the consumer on the home page, and a product purchase page which enables the purchase of the product disclosed on the product information page and which affiliates with each shop;

an administrator who operates the purchase support site to notify the shop of the product purchased through the purchase support site; and

a terminal which can be used by the consumers and which enables access to the purchase support site.

### BRIEF DESCRIPTION OF THE DRAWINGS

FIG. 1 is an overall view showing a structure of a certain product sales system according to one example of the present invention.

FIG. 2 is a view disclosing an example of product item number information attached to the product provided by the product sales system.

FIG. 3 is a view showing a structure of a homepage for consumers which constitutes the sales support site of the product sales system.

FIG. 4 is a view showing an example of the product information page which constitutes the sales support site.

FIG. 5 is a view showing one example of a stock confirmation page constituting a part of the support site.

FIG. 6 is a view showing one example of a product reservation page constituting a part of the support site.

FIG. 7 is a view showing one example of a web page for making a final confirmation of the reservation of the product.

FIG. 8 is a view showing one example of the product purchase page constituting a part of the site.

FIG. 9 is a view showing one example of the item information transmission page constituting a part of the site.

### DETAILED DESCRIPTION OF THE PREFERRED EMBODIMENTS

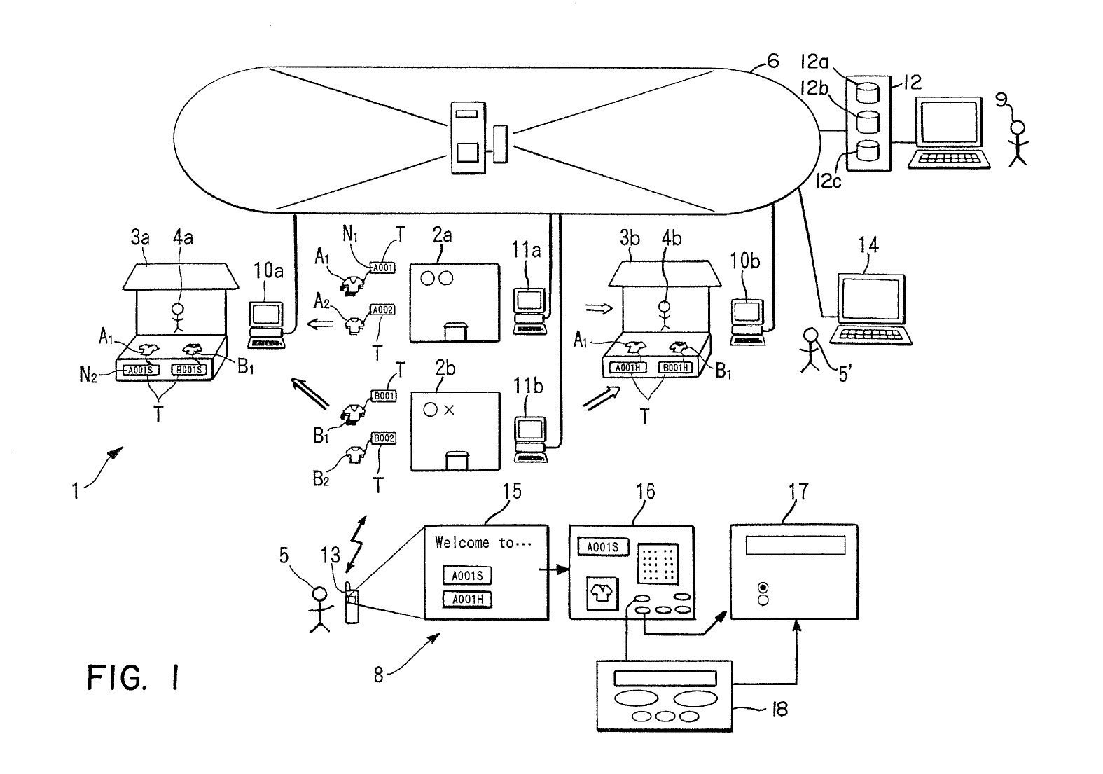

FIG. 1 is an overall structure view showing a product sales system 1 according to one example of the present invention. In FIG. 1, reference numbers 2a and 2b denote manufacturers (in this embodiment, apparel manufacturers are exemplified, and they will be referred to as apparels hereinafter) of each kind of products A₁, A₂, . . . , B₁, B₂ . . . . Reference numerals 3a and 3b denote shops which display and sell at the shops the products A₁ and B₁, . . . of these apparels 2a and 2b. Reference numerals 4a and 4b denote shop clerks of each of the shops 3a and 3b. Reference numeral 5 denote a consumer, and reference numeral 5′ denotes an acquaintance of a consumer 5 who is a different consumer.

Reference numeral 6 denotes the internet which is one example of a network. Reference numeral 7 denotes a web server which constitutes the internet 6. Reference numeral 8 denotes a purchase support site made public on the internet. Reference numeral 9 denotes an administrator who operates the purchase support site 8. Each of he shops 3a and 3b and the apparels 2a and 2b are provided with the POS (Pont of Sales) terminal 10a and 10b and 11a and 11b connected to the internet 6. The administrator 9 has a purchase support server 12 connected to the internet 6.

On the other hand, the consumer 5 has a internet corresponding type mobile telephone 13 as one example of the mobile terminal which enables connection to the network such as the internet or the like. The consumer 5′ has an information processing apparatus 14 (hereinafter referred to as a personal computer 14) connected to a normal telephone wire. Incidentally, it goes without saying that the terminal used by the consumers 5 and 5′ may be a PDA which is a mobile terminal in addition to the mobile telephone 13 and the personal computer 14.

Furthermore, the purchase support site 8 has a home page 15 prepared for each of the consumers 5 and 5′. Furthermore, the purchase support site 8 has a product information page 16 for making public information on the products A₁, A₂, . . . B₁, B₂ . . . obtained from each of the affiliated shops 3a and 3b and apparels 2a and 2b and the a product purchase page 17 for purchasing the products A₁, A₂, . . . , B₁, B₂ . . . and a product reservation page 18 for reservation.

The home page 15 is individually prepared on the basis of a request from the consumer 5. The home page 15 is prepared in the number of the consumer 5 who uses the product sales system 1. Incidentally, at the time of registration of the consumer 5, the consumer 5 registers the address, the name, the telephone number, the mail address, and the ID number 15 for opening the home page 15 by such means as e-mail and mail.

In addition, the consumer 5 can register individual information such as the number of credit card or the like required at the time of, for example, the settlement of account in accordance with his or her will with a safe method such as mail or the like in accordance with his or her will. Furthermore, it is desired that the ID number can be easily remembered, and can be appropriately selected on the side of the consumer 5. Consequently, it is desired that the consumer 5 can set the ID number such as “AKIKO” or the like by using their own name.

Then, this individual information is conserved on the purchase support server 12 as individual information database 12a. Next, when the individual information database 12a is prepared, the home page 15 to the consumer 5 is prepared so that a URL for opening the home page 15 is sent to the consumer 5 by e-mail or mail.

Incidentally, in this example, the home page 15 is constituted in such a manner that when the consumer 5 opens his own home page 15, the ID number is requested so that only the consumer 5 can open his own home page thereby improving the security. However, in the case where the terminal for opening the home page 15 is a mobile telephone 13 or the like, the number of the mobile telephone is identified in place of the ID number so that the home page 15 can be opened. Furthermore, in the case where the terminals 13 and 14 for opening the home page 15 are almost determined, the home page 15 may be opened by using the ID number of the information processing apparatus 13 and 14 which constitute the terminal.

Each of the home pages 16 through 18 is operated with affiliation with at least the shops 3a and 3b. At this time, information on products A₁, A₂, . . . , B₁, B₂, . . . , is conserved in the purchase support server 12 as product information database 12b. Then, the product item number information N is used for the identification of each of the products A₁, A₂, . . . , B₁, B₂, . . . . That is, each of the pages is constituted in such a manner that information on the required product can be drawn from a huge product information database 12b with the product item number information N.

In the products A₁, A₂, . . . B₁, B₂, . . . sold at the shops 3a and 3b, peculiar product item number information is disclosed and attached on a tag T and a label so that the shops 3a and 3b identifies each of the products A₁, A₂, . . . B₁, B₂, . . . with this product item number information N.

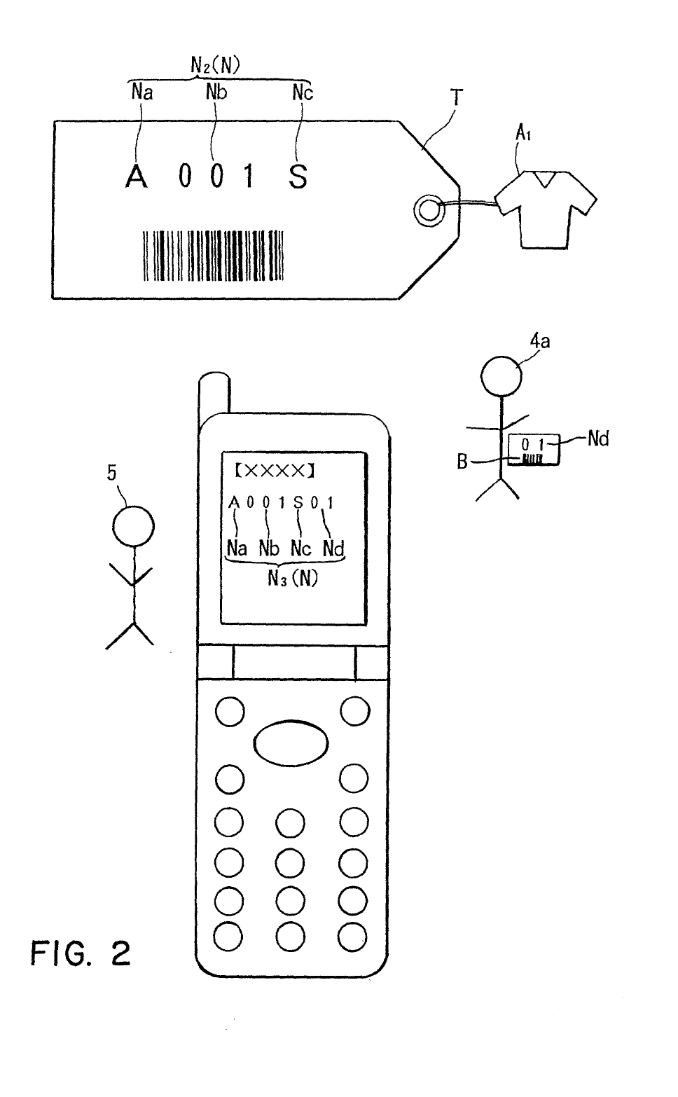

FIG. 2 is a view disclosing an example disclosing an item number information N disclosed in the tag T and the label, and the item number information N in this example is prepared for each product. This product item number information N includes product item number information attached by the apparels 2a and 2b, product item number information N₂ and N₃ attached by each of the shops 3a and 3b. Then, these product item number information N has, for example, the manufacturer information Na for specifying the apparels 2a and 2b, a serial number Nb for each of the apparels 2a and 2b, the shop information No and clerk information Nd.

Next, a method for generating the product item number information N will be explained. That is, each apparel 2a prepares the product item number information N₁ by attaching the manufacturer information Na and the serial number Nb to the products A₁ and A₂ of their own company along with the production of new products and supplies the products A₁ and A₂ to the shop together with the product item number information N₁.

At this time, since the apparels 2a and 2b generate the product item number information N₁ by using “A” of the allocated manufacturer information Na and the manufacture serial number “001” of the product A₁ of the company, it is not necessary to have a consultation with a different apparel 2b at the time of the generation of the product item number information N₁. Consequently, the shop can swiftly correspond to the sales of the product.

Next, each shop 3a adds “S” in the shop information No allocated to the product item number information N₁ to prepare the product item number information N₂ comprising these items of information Na through No and attaches the product item number information N₂ to the products A₁, A₂, . . . as a tag T or a label to sell the product. Furthermore, the clerk information Nd is allocated to each clerk 4a at the shop 3a, and this information is clearly shown as a name tag. That is, the product item number information N₃ can be prepared only by attaching the clerk information Nd to the product item number information N₂. Incidentally, these items of information Na through Nd is not only represented in characters but is displayed as a bar code B.

Furthermore, detailed information on each of the products A₁, A₂, . . . , B₁, B₂, . . . may be transmitted to the purchase support server 12 from the apparels 2a and 2b, but the detailed information may be transmitted from the shops 3a and 3b to the purchase support server 12. In this example, since the product is an apparel product and the shops 3a and 3b set the sales prices of the product fixed by the apparels 2a and 2b, it is desired that detailed information such as the product sales prices of each of the products A₁, A₂, . . . , B₁, B₂ . . . may be transmitted from the apparels 2a and 2b to the purchase support server 12.

However, in the case where the products whose prices are not strictly observed are handled, the sales prices of the product corresponding to each of the product item number information N₂ is set after the shops 3a and 3b generates the product item number information N₂. Information on the size of the product and the material quality thereof constitute the detailed information on the product, so that this detailed information on the product may be transmitted to the purchase support server 12 in association with the product item number information N₂.

That is, when the new product arrives from the apparels 2a and 2b, each of the shops 3a and 3b can easily prepare the product item number information N₂ and N₃ with the result that shops 3a and 3b can swiftly handle the sale of new products thanks to the detailed information on the product. The administrator 9 can put in order detailed information from the apparels 2a and 2b, or from the shops 3a and 3b with the product item number information N. Furthermore, the product item number information N₂ includes the product item number information N₁ defined by the apparels 2a and 2b so that the administrator can easily put in order the detailed information on the products.

To the purchase support server 12, the product item number information N₂ and the detailed information on the products A₁, A₂, . . . , B₁, B₂, . . . can be transmitted, for example, via the POS terminal 10a and 10b. Incidentally, in this example, the POS terminal 10a and 10b are linked with the purchase support server 12 via the network (not necessarily via the internet 6), the purchase support server 12 grasps in a package the retail stock at each of the shops and is conserved in the purchase support server 12 as the stock control database 12c.

The administrator 9 prepares the product information database 12b for each of the product item number information N₂ by summarizing the detailed information on each of the products accumulated in the purchase support server 12. Then, the detailed information registered in this product information database 12b is reflected on the product information page 16. In this manner, the purchase support site 8 is operated in affiliation with each shop 3a and 3b and apparels 2a and 2b.

Consequently, the product sales system 1 in this example has the apparels 2a and 2b, the shops 3a and 3b, the internet 6, the purchase support site 8 operated on the internet, the administrator 9 and the product item number information N. Incidentally, in this example, for the simplification of the structure, only two apparels 2a and 2b and two shops 3a and 3b are disclosed. However, it goes without saying that the present invention is not intended to restrict the number of the apparels 2a and 2b, the number of shops 3a and 3b, and the number of products A₁, A₂, . . . , B₁, B₂. . . .

Here, suppose that the consumer 5 visits the shop 3a and the consumer 5 can find a product (for example, a blouse) A₁ which which satisfied the consumer 5 under the introduction by the clerk 4a. The consumer 5 can put on the blouse for trial and can select the size and the color which go well with himself or herself. Besides, the consumer 5 can confirm the quality of the product by directly seeing the product.

At this time, the consumer 5 may instantly purchase the product at the shop 3a, but the consumer 5 can record the product item number information N on the home page 15 for the consumer 5 as a product which attracts his or her attention so that the consumer 5 can decide on the purchase of the product later. That is, the consumer 5 can generate the product item number information N₃ by adding the clerk information Nd to the product item number information N₃ attached to the product A1 while being attended by the clerk 4a. Then, the consumers 5 can input the product item number information N₃ from the mobile telephone 13 which they hold at hand or the PDA (not shown) to send the product item number information N₃ to the purchase support site 8. On the other hand, when the consumer 5 is not attended by the clerk 4a, the product item number information N₂ attached to the product A₁ can be sent as it is.

Incidentally, in the case where the consumer 5 does not have a mobile terminal such as an internet corresponding type mobile telephone 13 or the like, and in the case where a request is made from the consumer 5, the clerk 4a may input the product item number information N₃ from the information processing apparatus such as the POS terminal 10a or the like.

In the case where the POS terminal 10a is used for inputting the product item number information N, the bar code B (see FIG. 2) is read by using the bar code reader (not shown) or the like to send the bar code B. At this time, it is desired that the clerk information Nd attached to the name tag of the clerk 4a is displayed as a bar code B. In the case where the consumer 5 has a card disclosing the bar code representing the ID number, it is possible to get rid of the trouble of inputting the information from the keyboard.

Furthermore, the product item number information N may be sent by e-mail. In this case, the product item number information N can be sent by using almost all the mobile telephone 13 as the mobile terminal. In this case, the administrator 9 prepares a mail box for inputting the product item number information N for each of the consumers 5 within the purchase support site 8 on the internet, so that the product item number information N stored in the mail box is allowed to be reflected on the home page 15 of the consumers 5.

In any way, when the product item number information N₃ is input, the product item number information N input by the consumer 5 is reflected on the home page 15 on the internet 6, so that the detailed information on the product corresponding to each of the product item number information is confirmed and the product can be purchased. That is, even when the consumers 5 do not remember the detailed information on the product such as the price and the material, the consumers 5 can decide on the purchase of the product later while confirming the information.

At this time, since the product information which can be seen through the home page 15 is only the information on the product the consumer has a good impression on when the consumer 5 already visit the shops 3a and 3b, the consumers 5 are not overwhelmed by a huge amount of information and they can display only information on their favorite product with the result that the consumer 5 can order the product. That is, when the consumer 5 wants to purchase the product he or she wants to purchase, the consumer 5 do not have to go back to the shop so that the consumer 5 can swiftly order the product A₁ through the internet 6 (namely site 8) from the mobile telephone 13 which the consumer 5 holds at hand.

Furthermore, since the product item number information N includes the shop information No, the administrator 9 can know at which shop the consumer 5 has seen the product A₁ and the administrator 9 can notify of the purchased product A₁ the shop 3a at which the product item number information N is input. Consequently, the shop 3a which is notified of the purchased product A₁ can send the product A₁ from the stock to the consumer 5.

Next, the payment on the product set by the shop 3a can be obtained from the administrator 9. That is, the profit obtained in the internet shopping can be received by the shop 3a. Incidentally, the method for receiving the payment and the method for supplying the product are not restricted thereto. That is, for example, the product A₁ can be directly sent from the administrator 9. In such a case, the shop 3a can eliminate the need of storing a large amount of stock. Furthermore, it goes without saying that the consumer 5 can directly go to the shop to get the product A₁.

In particular, when the product item number information N includes the clerk information Nd, it is possible to judge which clerk 4a is associated with the sales of this product A₁ thereby making it possible to measure the sales record of each clerk 4a.

In addition, since the products introduced in the product sales system 1 are all supplied by the shop 3a which the consumer 5 visit, the consumer 5 does not purchase the same product through a different sales shop nor directly purchase the same product from the apparels 2a and 2b. Consequently, each shop 3a and 3b can participate in the shopping using the internet 6 with assurance. In actuality, the sales opportunity can be expanded with certitude by effectively using both advantages of the sales operation using actual shops 3a and 3b and sales operation through virtual shops on the internet.

Furthermore, in the case where the product A₁ is a product whose standard sales price is not strictly observed, only the price defined by the shop 3a is made public as the sales price of the product A₁ to be introduced in the product sales system 1 by registering the shop displayed price of the product A₁ at each of the shops 3a and 3b on the product information database 12b as detailed information on the product A₁. Consequently, even in the case where no stock is already left at the shop 3a where the consumer 5 find the product and the product is delivered from the stock of a different shop 3b which holds a sales promotion campaign, the sales price of the product at the shop 3b can be set to the same as the price at the shop 3a.

On the other hand, since the consumer 5 actually visits the shop 3a and confirms the quality of the product A₁, the consumer 5 has no worry about the product A₁. Furthermore, the consumer 5 does not need to feel worry about the purchase of products using the internet thanks to trust on the shop 3a. Besides, in the case of products such as clothes or the like in which individual difference generated by the external quality of the products affects the consumer 5, directly looking at the product is effective for getting rid of uneasiness on the side of the consumer 5.

Furthermore, in this example, since a product reservation page 18 is provided for making a reservation of down payment of the product before the purchase of the product, the consumer 5 can inspect the product with assurance and a situation can be prevented in which no stock is left when the consumer 5 decides to purchase the product.

Furthermore, the purchase support site 8 of this example has a function of transmitting the product item number information N₃ to the home page 15 of a different consumer 5′ who is a third party specified by the consumer 5. The consumer 5 can get an opinion and an advice from a different consumer 5′ with respect to the purchase of the product A₁. At this time, the third party consumer 5′ can confirm the image of the product A₁ which the consumer 5′ has found on the purchase support site 8, so that the consumer 5′ can confirm the detailed information on the product A₁ which cannot be expressed in words, and can pass an appropriate judgment on the product A₁.

In addition, in the case where the stock state of the product at each of the shops 3a and 3b is conserved as the stock control database 12c on the side of the administrator as can be seen in this example, a superfluous shop stock at a specific shop can be delivered to the shop which has exhausted the shop stock of the product with the result that the shop stock at all the shops 3a and 3b can be evenly exhausted. That is, even with respect to the product whose consumption amount is different from one area to another, a superfluous stock and insufficient stock can be suppressed so that a smooth distribution of the product can be promoted. Furthermore, the problem of the exhaustion of the stock can be settled by swiftly learning the product which sells well.

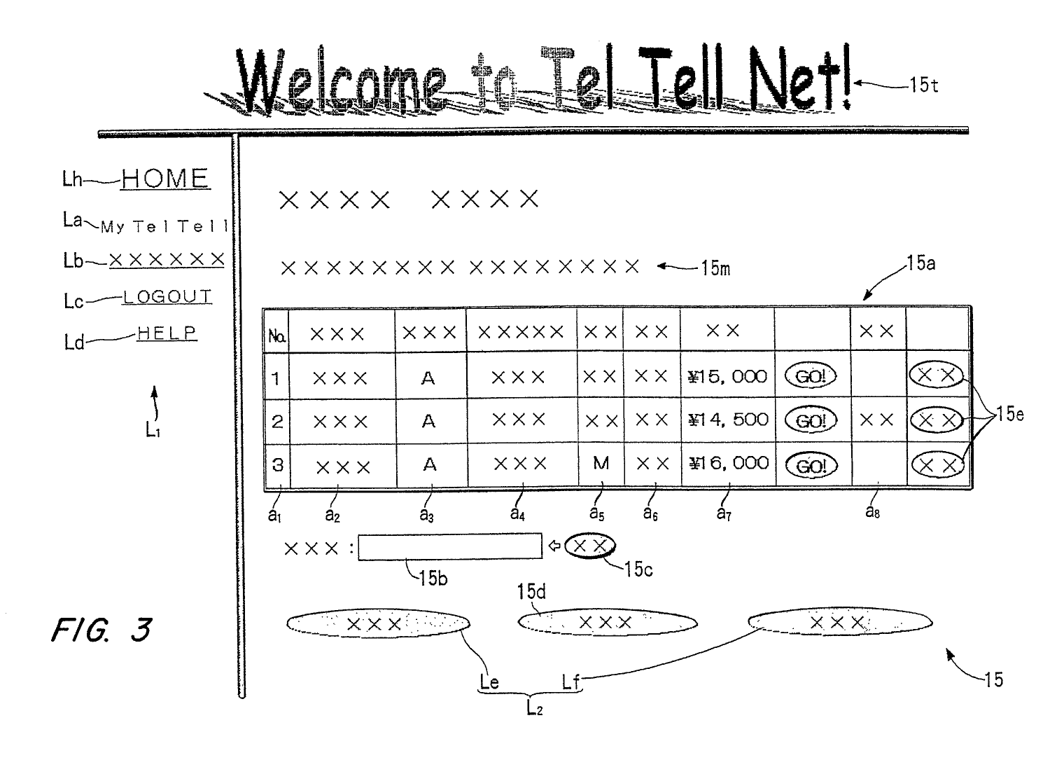

FIGS. 3 through 9 are views showing an example of the purchase support site 8 (hereinafter simply referred to as site 8) formed by using the product sales system 1 according to the present invention.

FIG. 3 is a view showing the home page 15 of the consumer 5 formed in the site 8. For example, the home page 15 has a title 15t of the home page 15, a conversation style message 15m, a list 15a on the product selected by the consumer, an input column 15b of the product item number information N, and a button 15c for adding the product item number information N input via the input column 15b to the list 15a, an all product clear button 15d for eliminating all the products shown in the list 15a, and link buttons L₁ and L₂ for jumping to each web page constituting the present site 8.

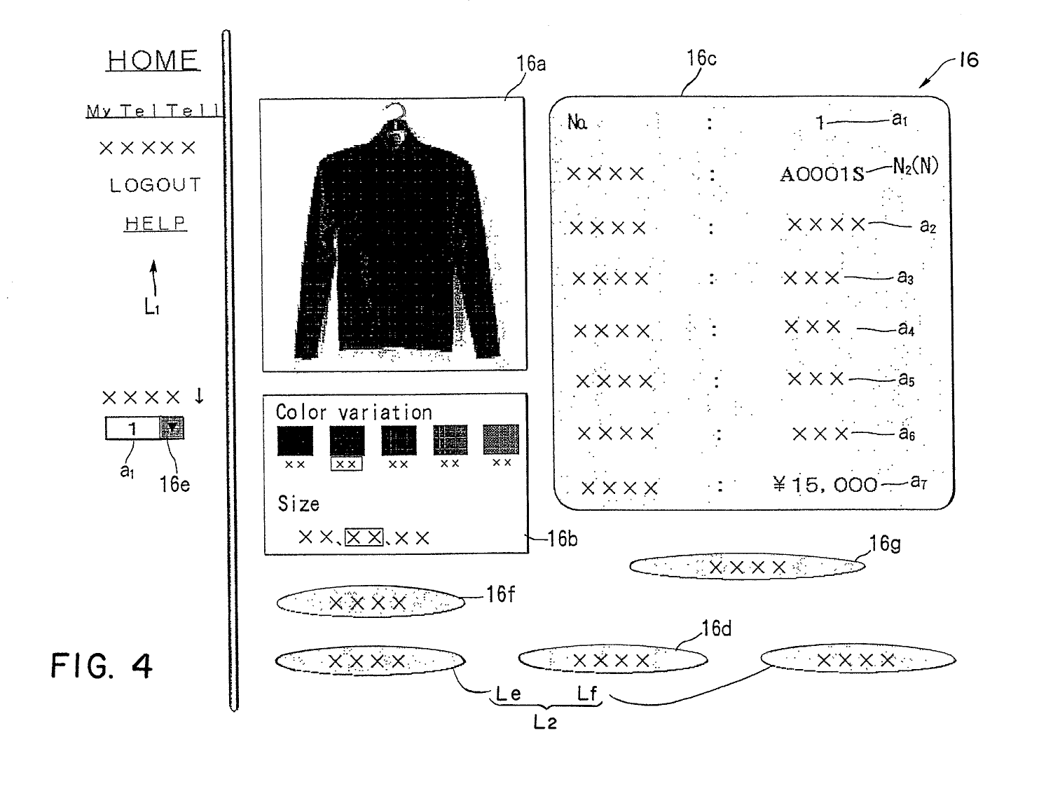

Furthermore, the list 15a has a link button L₃ for jumping to the product information web page 16 shown in FIG. 4, a column for confirming the state a₈ of the down payment reservation for the product, and a clear button 15e for individually clearing each product in addition to a column for disclosing detailed information on the product such as reference number a1 of each product, a product name a₂, a brand name a₃, a shop name a₄ where the product is checked, a size a₅ f the product, a color a₆, a sales price a₇ or the like. However, it goes without saying that according to the present invention, the content shown as the list 15a is not restricted to the above example.

Incidentally, with respect to the link button L₁ of this example, the same content is represented on any page of FIGS. 4 through 9. The link button L₁ has a link button La for jumping to the home page 15, a link button Lb for jumping to the web page laid out so that the external appearance is favorable when displayed with the mobile telephone 13, a link button Lc for jumping to the web page for log out processing and a link button Ld for jumping to the home page for explaining the usage method of this site 8, and a link button Lh for jumping to the home page of this site 8.

Although the disclosure of the home page of the site 8 is omitted in this example, the system is constituted in such a manner that the consumer 5 inputs the ID number of the consumer 5 via the home page of the site 8 at first when using the site 8 so as to be able to jump to the home page of the site 8. Furthermore, the system is constituted in such a manner that the consumer can make a new registration via the home page of this site 8. Incidentally, in this example, with respect to the connection after the second time, the system is constituted in such a manner that the consumer 5 is identified with the telephone number and apparatus number or the like of the terminals 13 and 14, so that the home page 15 can be displayed from the very beginning without displaying the home page of the site 8 thereby getting rid of the trouble of inputting the ID number.

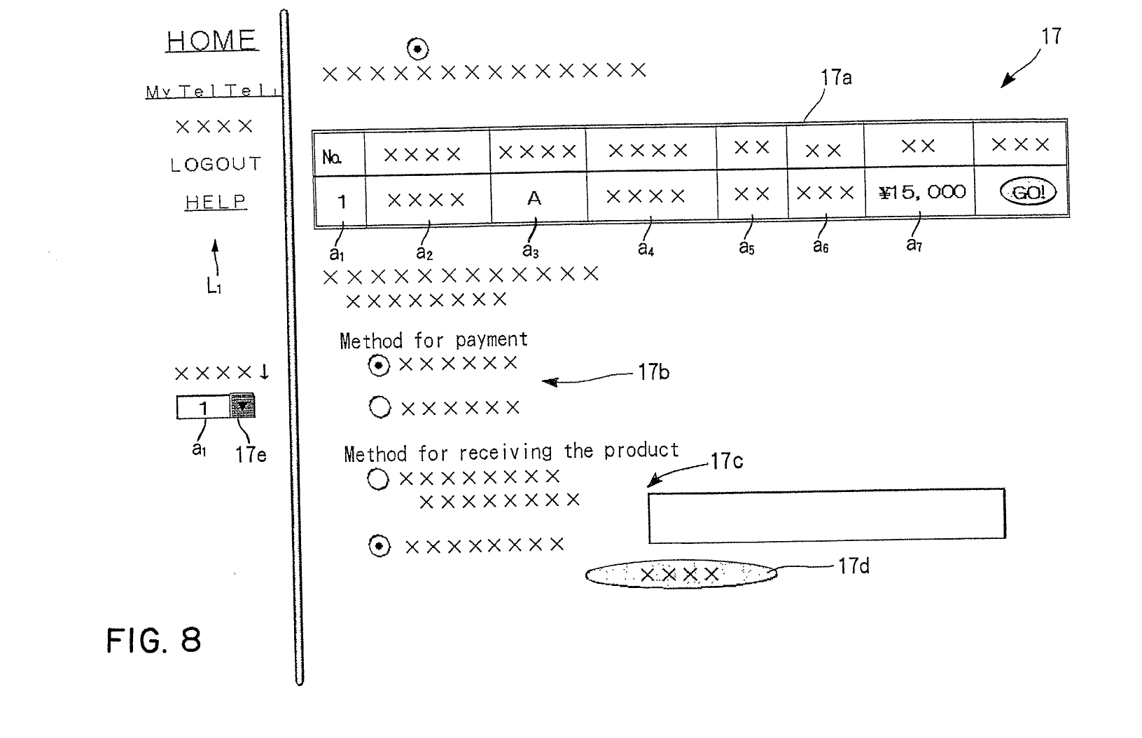

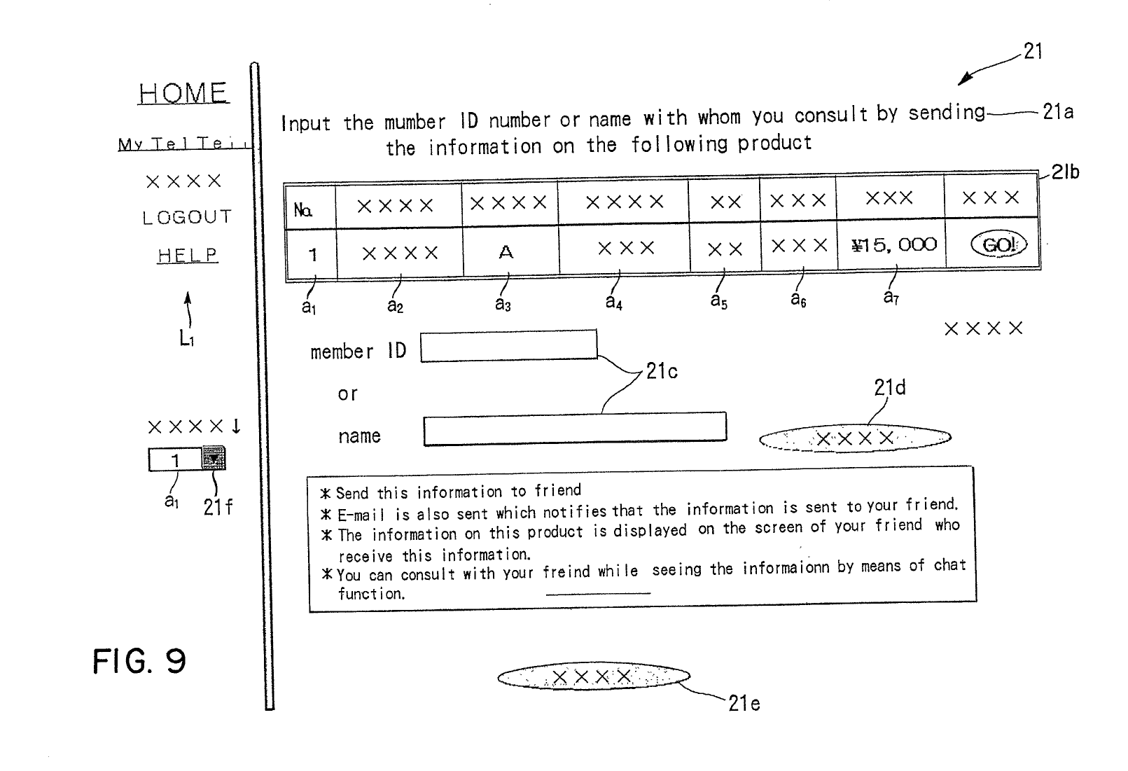

The link button L₂ has, for example, a link button Le for jumping to the product purchase page 17 shown in FIG. 8, and a link button Lf for jumping to the product item number information transmission page 21 shown in FIG. 9, and the link button L₂ is also displayed on any of the web page shown in FIGS. 4 through 6.

Consequently, the consumer 5 can see the list on the products checked by the consumer 5 when connected to the site 8 with the terminal such as a mobile telephone 13 or the like. Furthermore, the product item number information of a new product can be input via the input column 15b and the button 15c to this list 15a, the product once input can be eliminated with the clear button 15e or all product clear button 15d, and the product reserved through the down payment can be confirmed from the display column on the down payment reservation state of the product a₈.

In particular, since only the product already selected and checked by the consumer 5 is displayed on the list 15a, the consumer 5 is not overwhelmed by a huge amount of information so that the target product can be easily selected.

FIG. 4 is a view showing one example of the product information page 16 of each product displayed when the link button L₃ in the list 15a is pressed on the home page 15.

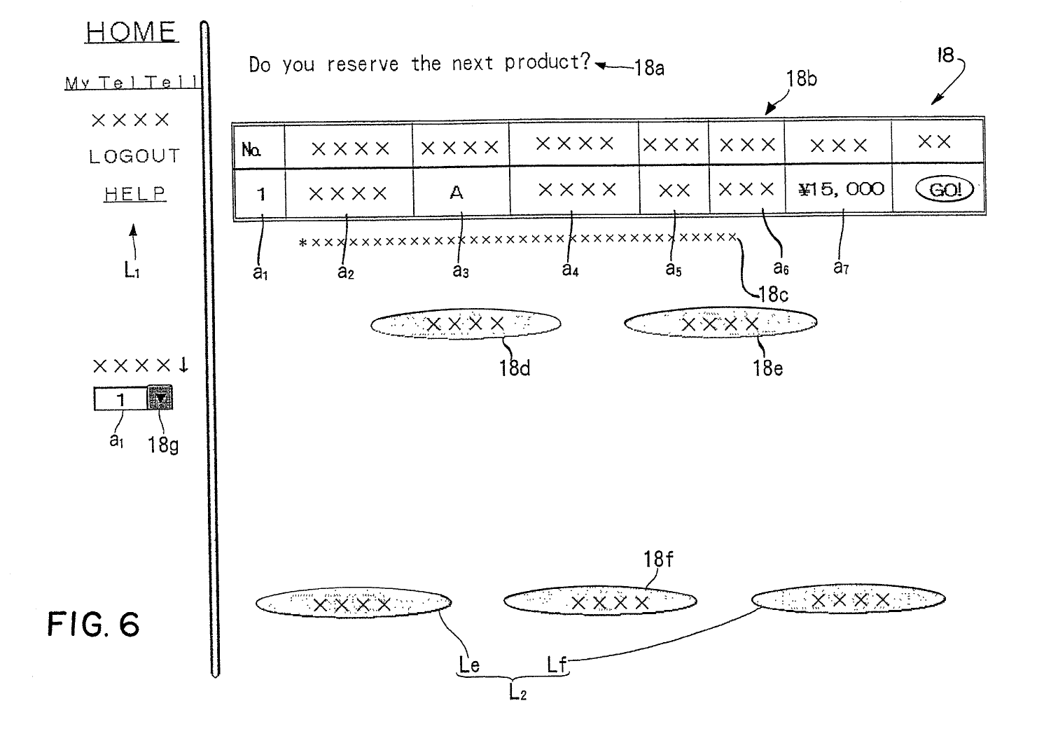

This product information page 16 has a display portion 16a for displaying a photograph in which the product is taken; a selection portion 16b for selecting a variation of the product, a detailed display portion 16c for displaying detailed information a₁ through a₇ on the product and the product item number information N₂ (N), a clear button 26d for clearing the displayed product from the list, and a selection column 16e for displaying detailed information on the other product selected by the consumer 5, a link button 16f for jumping to the product reservation page 18 shown in FIG. 6 for the down payment reservation, and a link button 16g for jumping to the stock confirmation page 19 for confirming the stock of the product.

The display portion 16a discloses a product in a variation selected with the selection portion 16b. For example, when the selection of the color is changed with the selection portion 16b, it is desired that the content of the photo be changed. In the same manner, it is desired that the selection of the variation by the selection portion 16b be reflected in the detailed information a₁ through a₇ disclosed on the detailed display portion 16c. However, it goes without saying that even when the selection by the selection portion 16b is changed, the content of the display portion 16a is not changed and only the color sample is displayed on the selection portion 16b.

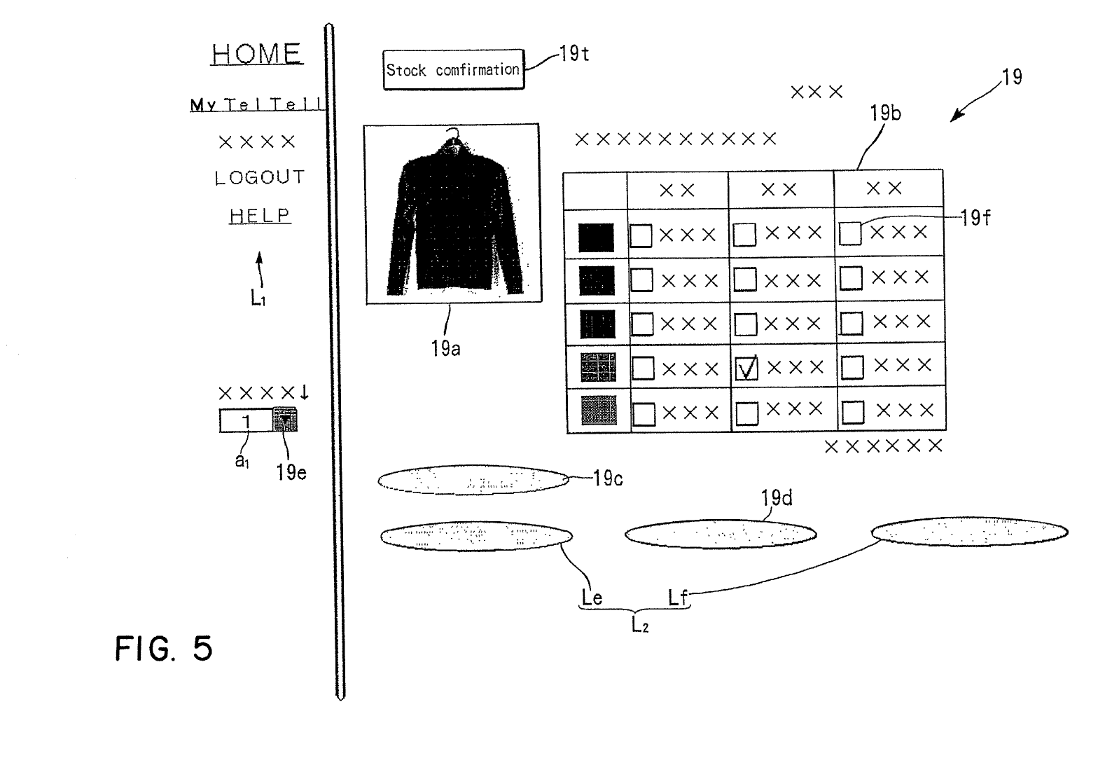

FIG. 5 is a view disclosing one example of a stock confirmation page 19 displayed when the link button 16 g is pressed.

Then, this stock confirmation page 19 is prepared on the basis of information accumulated in the stock control database 12c, and the stock confirmation page 19 has a title 19t of this page, a display portion 19a having an image on which the product is photographed, a display portion 19b showing a list on the presence or absence of the stock of each variation of the product, a link button 19c for jumping to the product reservation page 18 for making a down payment reservation on the product, a clear button 19d for clearing the product to be displayed from the list, a selection column 19e for displaying the stock state of the other product selected by the consumer 5, and a link buttons L₁ and L₂.

In the list of the display portion 19b, the presence or the absence of the stock of the product is displayed by classifying the stock state into “present”, “few” and “out of stock”, so that the consumer can confirm the stock state of the product whose product item number information is transmitted. Then, in each of the column, a check column 19f is formed. Pressing the link button 19c in the state in which the check column is checked enables jumping to the product reservation page 18 shown in FIG. 6, so that the down payment reservation is made on the product.

Incidentally, the stock situation described on the display portion 19b does not show the stock of the product only at the shop which the consumer 5 visited, but shows on the stock control database 12c the stock state of all the products at all the shops including all the shops affiliated with the product sales system 1. Consequently, even if the shop (for example, Shibuya shop) the consumer 5 visits does not have the stock of the product, the stock of the product the other shop has is delivered to the consumer 5 to yield a profit to the Shibuya shop when the other shop has the stock of the product.

Furthermore, the administrator monitors the stock control database to analyze the purchase reservation state of the consumer and the actual purchase activity, so that the administrator can request the additional production of the product to the apparels 2a and 2b swiftly. Furthermore, the administrator moves the product while watching the stock state at each of the shops 3a and 3b. Consequently, each of the shops 3a and 3b can decrease the insufficient state of the stock of the product and the superfluous sate of the stock of the product as much as possible thereby optimizing the distribution of the product.

Now, in FIG. 5, since the check column in pink No. 9 is checked so that pressing the link button 19c in this state enables displaying the product reservation page 18.

In FIG. 6, the product reservation page 18 has a message 18a for asking whether or not the down payment reservation of the product is conducted, a chart 18b for disclosing the detailed information a₁ through a₇ on the product which is selected, a message 18c for confirming the sum of the down payment required for the down payment reservation, a link button 18d for carrying out a procedure of making the down payment reservation, a button 18e for canceling the down payment reservation to return to the original page, a clear button 18f for clearing the product, and a selection column 18g for conducting the down payment reservation of the other product selected by the consumer 5 and the link buttons L₁ and L₂.

Furthermore, the system is constituted in such a manner that the chart 18b is provided with a button 18h for confirming the details of the product so the product can be confirmed again before making a down payment reservation. That is, the consumer 5 can request the down payment reservation on the product whose stock remains only a little and the consumer 5 still remains undecided to purchase, so that the consumer 5 can take time to deliberate on the need of purchasing the product.

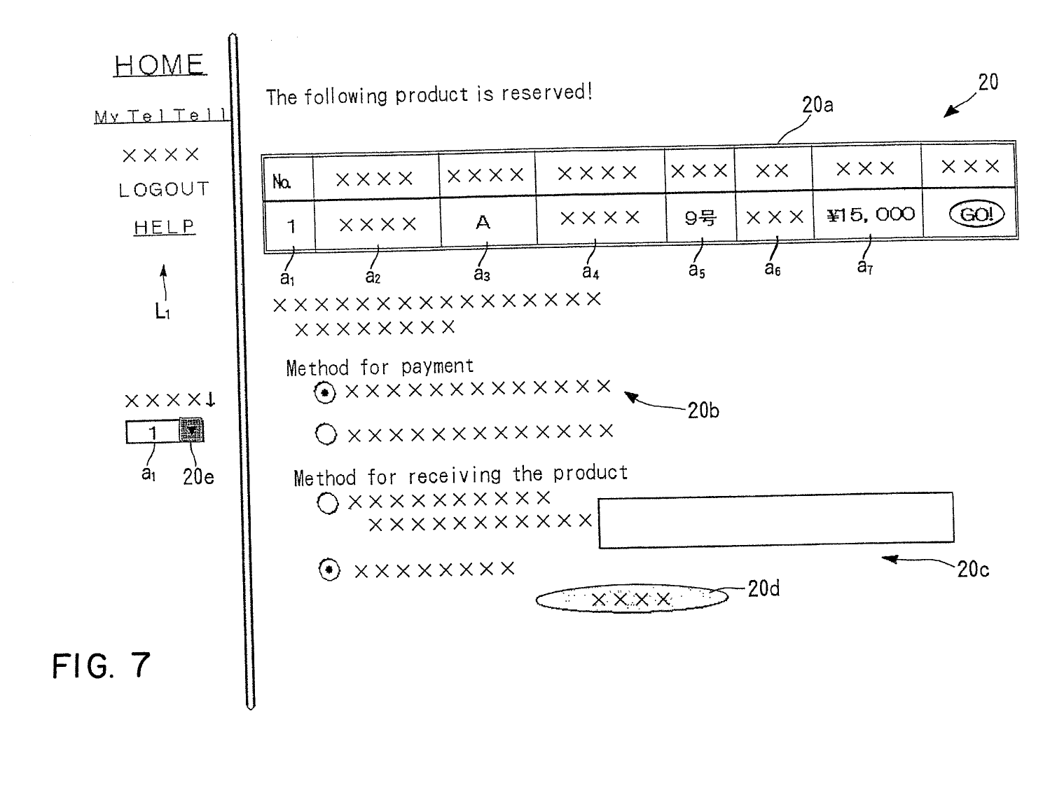

Now, suppose that the consumer 5 decides to make a down payment reservation on the product and presses the link button 18d, which enables jumping to the final confirmation page 20 of the down payment reservation shown in FIG. 7. This final confirmation page 20 has a chart 20a for displaying detailed information a₁ through a₇, a selection item 20b of information on the settlement of account, an input column 20c on the receipt of product, a confirmation and sending button 20d, a selection column 20e for instructing the down payment reservation on the other product selected by the consumer 5, and the link button L₁.

FIG. 8 is a view showing one example of the product purchase page 17 to be jumped from each of the pages 15, 16, 18 and 19 at the time of pressing the link button L₁.

The product purchase page 17 of this example has, for example, a chart 17a for displaying detailed information a₁ through a₇ on the product, a selection item 17b of information on the settlement of account, the input column 17c on the receipt of product, a selection column 17d for purchasing other product selected by the consumer 5 and the link button L₁.

Consequently, when the consumer 5 decides on the purchase of the product the consumer 5 has checked, the consumer 5 displays the product purchase page 17 by using a terminal such as the mobile telephone 13, so that the consumer 5 can purchase the product by pressing the confirmation and sending button 17d. That is, the consumer 5 does not have to go back to the shop to purchase the product.

Incidentally, in this example, since the payment on the product and the receipt thereof is specified at the shop through the selection item 17b and the input item 17c, the consumer 5 can drop in at the shop to receive the product later. At this time, the shop already prepares the delivery of the product so that the consumer can swiftly receive the product with certitude.

FIG. 9 is a view showing one example of the product item number information transmission page 21 to be jumped at the time of pressing the link button Lf from each of the pages 15, 16, 18, and 19 of FIGS. 3 through 6.

This product item transmission page 21 has, for example, a message 21a, a chart 21b for displaying detailed information a₁ through a₇ on the product, an input column 21c for specifying the consumer 5′ for transmitting the product item number information N, a link button 21d for jumping to a web page (not shown) for specifying a plurality of transmission addresses, a confirmation and sending button 21e, a selection column 21f for transmitting the product item number information N of the other product selected by the consumer 5, and the link button L₁.

Consequently, the consumer 5 can transmit the product item number information N to the third party with respect to the favorite product. At this time, in the case where the consumer 5 is acquainted with the ID number of the consumer 5′ the consumer can transmit the product item number information N to the specified consumer 5′ by inputting the ID number in the input column 21c. On the other hand, even in the case where the consumer 5 does not know the ID number of a different consumer 5′ the consumer 5 want to specify, the purchase support server 12 can transmit the product item number information N by retrieving the registered individual information database to detect the consumer.

Besides, the purchase support server 12 discloses the product item number information N transmitted to the home page 15 of the consumer 5′ upon receipt of the transmission of the product item information N while notifying the arrival of information by sending e-mail to the mail address of the consumer 5′. By doing so, the consumer 5′ can confirm the detailed information on the product checked by the consumer 5 in the same method in the explanation of FIGS. 3 through 5 described above so that the consumer 5′ can provide an appropriate opinion and advice.

On the other hand, in the case where the consumer 5′ is a friend, the consumer 5 can notify close fellows of favorite product which the consumer 5 newly finds. That is, when the product his friend is seeking at all times is found, this product item number information N can be effectively used.

In this manner, information is briskly exchanged between consumers 5 and 5′ The shop can further expand the sales opportunity and increase the sales of the product.

According to the present invention, since the consumer 5 places an order of the product which the consumer 5 confirms by seeing the actual product, the consumer does not feel unnecessary worry about the internet shopping. Moreover, since only the sales price of the product at the shops the consumer 5 visits is displayed, the shop can actively participate in the internet shopping. Still furthermore, the profit obtained in the sales of the product can be brought back to the shop, the shop can effectively conduct commercial trade by making use of both the advantages of the actual shop and the shop on the internet.

Since the above example is a simple example for conducting the method for selling the product and the product sales system according to the present invention, the present invention is not limited to the above structure. That is, when each shop 4a,4b is located in a restricted place such as a department store and a large scale store, it becomes possible that the department store and the large scale store can serve as an administrator so that the stores can deliver the product to the consumer at one time and the customer can settle the account of the product at one time when getting out of the department store and large scale stores.

That is, the customer is not required to carry the products at all times and the customer is not required to settle the account for each item of products. Incidentally, the network used in the case may be a connection of each terminal using the LAN or an intranet.

As has been explained above, according to the present invention, the consumer can obtain accurate information on the product by inputting through the use of the terminal the product item number information of the product the consumer finds by visiting the shop on the home page for the consumer. The administrator refers the detailed information on the product for the product information database which is already constructed to put in order information into necessary information so that such information is supplied by using the product information page on the purchase support site.

Furthermore, the consumer can purchase a product disclosed on the product information page from the product purchase page so that they can purchase the product which attracted his or her attention when doing the window shopping without going back to the shop again. At this time, since the purchase support site selects only information on the product with the product item number information input by the consumer 5, the consumer is not overwhelmed by a huge amount of information and can instantly find only the product they are satisfied with so that they can purchase the product.

Furthermore, at the purchase support site, the shop can gain as its own profit the profit obtained through the sale occasion by allowing the standard sales price of the product (the product sales price at the shop which the consumer visits) to be displayed on the site. That is, the purchase support site of the present invention is formed with affiliation with each shop so that the shop can actively participate in the opening of the internet shop by the purchase support site.

On the other hand, there is provided an advantage in that the consumer can select and purchase the product they require more even with respect to the same product by selecting several items of products which attracted the attention of the consumer at one time window shopping. In particular, since the consumer actually visits each shop, actually sees the product and confirms the quality thereof so that the consumer does not have to feel any reluctance to purchase the product through the internet.

Since the shop is notified of the product purchased by the consumer, each shop supplies the product to each of the consumers to gain the profit. Furthermore, in the case where the administrator supplies the product to the side of the consumer, the shop is notified of the purchase of the product so that the shop can gain the profit from the administrator. In this case, the shop can eliminate the need of stocking a large amount of the product. That is, the shop yields the profit even in the sales through the internet shopping, so that the shop can actively participate in the internet shopping.

What is claimed is:

1. A method for selling products characterized by comprising:
adding product item number information which specifies each item of products and includes shop information specifying shops which sell the product to each item of products so that the shops sell the product while disclosing the product item number information; and
allowing an administrator to operate a purchase support site which has at least a homepage for each consumer, a product information page for displaying information on each item of products corresponding to each product item number information input by the consumer on this homepage, and a product purchase page which enables consumers to purchase a product disclosed on this product information page and which affiliates with each shop thereby allowing the administrator to notify the purchased product to the respective shop through the product purchase page.

2. The method for selling products according to claim 1, wherein said consumer input the product item number information from a mobile terminal.

3. The method for selling products according to claim 1 or 2, wherein said product item number information includes manufacturer information for specifying the manufacturer of the product, each manufacturer notifies a serial number for each manufacturers to the administrator and each shop in accordance with sales of a new product, and the administrator and each shop prepare the product item number information by using the manufacturer information for specifying the manufacturer and the serial number.

4. The method for selling products according to any of claims 1 through 3, wherein said product item number information includes clerk information for specifying the clerk on the side of the shop.

5. The method for selling products according to any of claims 1 through 4, wherein said shop notifies the number of stock of each product to the administrator and the administrator notifies at least the presence of the stock of each product via the purchase support site to the consumer.

6. The method for selling products according to claim 5, wherein said administrator monitors the decrease state of the number of the stock of each product and requests the additional production of the product which is insufficient in the stock.

7. The method for selling products according to claim 5 or 6, wherein said administrator monitors the decrease state of the number of the stock of each product, and the administrator takes a procedure for enabling the product sold at a shop where the stock of the product is insufficient to be delivered to the consumers from a different shop where the stock of the same product is superfluous.

8. The method for selling products according to any of claims 1 through 7, wherein said administrator prepares the product reservation page which enables the consumer to make a purchase reservation of the product which is introduced on the product information page, and a down payment of the reserved product is made.

9. The method for selling products according to any of claims 1 through 8, wherein said administrator transmits the product item number information of the product input by the consumer specified by the consumer by using the purchase support site to a different consumer home page specified by the consumers.

10. A product sales system characterized by comprising:
product item number information which specifies each item of product and which is attached with shop information specifying a shop which sells the product;
a shop which sells the product while disclosing the product item number information;
a purchase support site which has a home page for each of the consumers, a product information page for displaying information on each product corresponding to the product item number information input by the consumer on the home page, and a product purchase page which enables the purchase of the product disclosed on the product information page and which affiliates with each shop;
an administrator who operates the purchase support site to notify the shop of the product purchased through the purchase support site; and
a terminal which can be used by the consumers and which enables access to the purchase support site.

11. The product sales system according to claim 10, wherein a information terminal owned by said consumer that enables the consumer to input the product item number information is included.

12. The product sales system according to claim 10 or 11, wherein said product item number information includes manufacturer information for specifying the manufacturer of the product, and the information is prepared by using the manufacturer information for specifying the manufacturer of the product and a serial number for each manufacturer of which each manufacturer notifies the administrator and the shop in accordance with sales of a new product.

13. The product sales system according to any of claims 10 through 12, wherein said product item number information includes clerk information for specifying the clerk on the side of the shop.

14. The product sales system according to any of claims 10 through 13, wherein said purchase support site notifies consumers of the presence or absence of each product on the basis of the number of stock of each product of which each shop notifies the administrator.

15. The product sales system according to any of claims 10 through 14, wherein said purchase support site has a product reservation page which enables the consumer to make reservation of the product introduced on the product information page, and make a down payment reservation of the product.

16. The product sales system according to any of claims 10 through 15, wherein said purchase support site has a function of transmitting the product item number information of the product input by the consumer to the home page of a different consumer specified by said consumer.
